(19) United States
(12) Patent Application Publication
(10) Pub. No.: US 2017/0129088 A1
(43) Pub. Date: May 11, 2017

(54) ADAPTIVE HAMMER CONTROL SYSTEM

(71) Applicant: Caterpillar Inc., Peoria, IL (US)

(72) Inventors: Koushik Kabiraj, Ranchi (IN); Chetan V. Dahiwal, Chennai (IN); Anuop Udayakumar, Chennai (IN)

(73) Assignee: Caterpillar Inc., Peoria, IL (US)

(21) Appl. No.: 15/413,061

(22) Filed: Jan. 23, 2017

(51) Int. Cl. B25D 9/26

(52) U.S. Cl. CPC B25D 9/26; B25D 2250/221

(57) ABSTRACT

A control system for a hydraulic hammer is provided. The control system includes a sensing unit configured to sense position and rebound acceleration of a piston of the hydraulic hammer. The control system further includes an electronic control module (ECM) in communication with the sensing unit, and configured to generate signals based on the sensed position and rebound acceleration of the piston. The control system further includes a selection unit configured to allow an operator to select between a manual mode and an automatic mode. The control system further includes a valve in communication with the electronic control module (ECM). The valve being configured to be operated between a closed position and an open position based on the signals generated by the electronic control module (ECM) to selectively move the piston.

### TECHNICAL FIELD

The present disclosure relates to hydraulic hammers, and more particularly relates to a control system for a hydraulic hammer.

### BACKGROUND

Machines, such as excavators, are provided with hydraulic hammers to break large and hard materials into smaller pieces to assist in easy disposal of such materials from one location to another. The hydraulic hammers generally include a reciprocally sliding piston. Typically, the hydraulic hammers are controlled by hydraulics and hence tend to operate with a consistent blows per minute and impact energy for a given fluid flow rate. Owing to such operational limitations of the hydraulic hammers, adjusting the operation of the hydraulic hammers according to site conditions and customer requirements may not be possible. Due to such limitation of not being able to control the blows per minute and the impact energy, it becomes difficult for an operator to identify if the hydraulic hammer is operating by providing optimum performance during operation. In addition, tracking and monitoring of the hydraulic hammers performance may be cumbersome, time consuming and inaccurate.

U.S. Pat. No. 7,156,188 hereinafter referred to as 'the '188 patent, describes a pile driver comprising a hammer for impacting a pile, a velocity sensor for measuring the velocity at impact, and a control system for adjusting the hammer stroke in accordance with the readings from the velocity sensor so that the optimal impact energy is imparted to the head of the pile. Optionally, the system further comprises a pile driving analyzer (including at least one strain gauge and/or an accelerometer) mounted on the side of the pile itself to determine whether the impact loading on the pile is below the maximum allowable stress. If the pile driving analyzer senses an overload of stress on the pile, the control system will reduce the velocity of the subsequent hammer stroke so that it no longer exceeds the maximum allowable stress. However, the '188 patent fails to disclose a system that improves performance of the hydraulic hammer.

### SUMMARY OF THE DISCLOSURE

In an aspect of the present disclosure, a control system for a hydraulic hammer is provided. The control system includes a sensing unit configured to sense position and rebound acceleration of a piston of the hydraulic hammer. The control system further includes an electronic control module (ECM) in communication with the sensing unit, and configured to generate signals based on the sensed position and rebound acceleration of the piston. The control system further includes a selection unit configured to allow an operator to select between a manual mode and an automatic mode. In the manual mode the operator selects number of blows per minute of the hydraulic hammer and in the automatic mode upon sensing rebound acceleration of the piston, the electronic control module (ECM) adjusts piston movement based on a work surface. The control system further includes a valve in communication with the electronic control module (ECM). The valve being configured to be operated between a closed position and an open position based on the signals generated by the electronic control module (ECM) to selectively move the piston.

Other features and aspects of this disclosure will be apparent from the following description and the accompanying drawings.

### BRIEF DESCRIPTION OF THE DRAWINGS

FIG. 1 is a side view of an exemplary machine having a hydraulic hammer:

FIG. 2. is a perspective view of the hydraulic hammer of FIG. 1;

FIG. 3 is a sectional view of the hydraulic hammer of FIG. 2 coupled to a tool of the machine;

FIG. 4 is a schematic block diagram of a control system of the hydraulic hammer showing a valve in an open position; and

FIG. 5 is a schematic block diagram of the control system of the hydraulic hammer showing the valve in a closed position.

### DETAILED DESCRIPTION

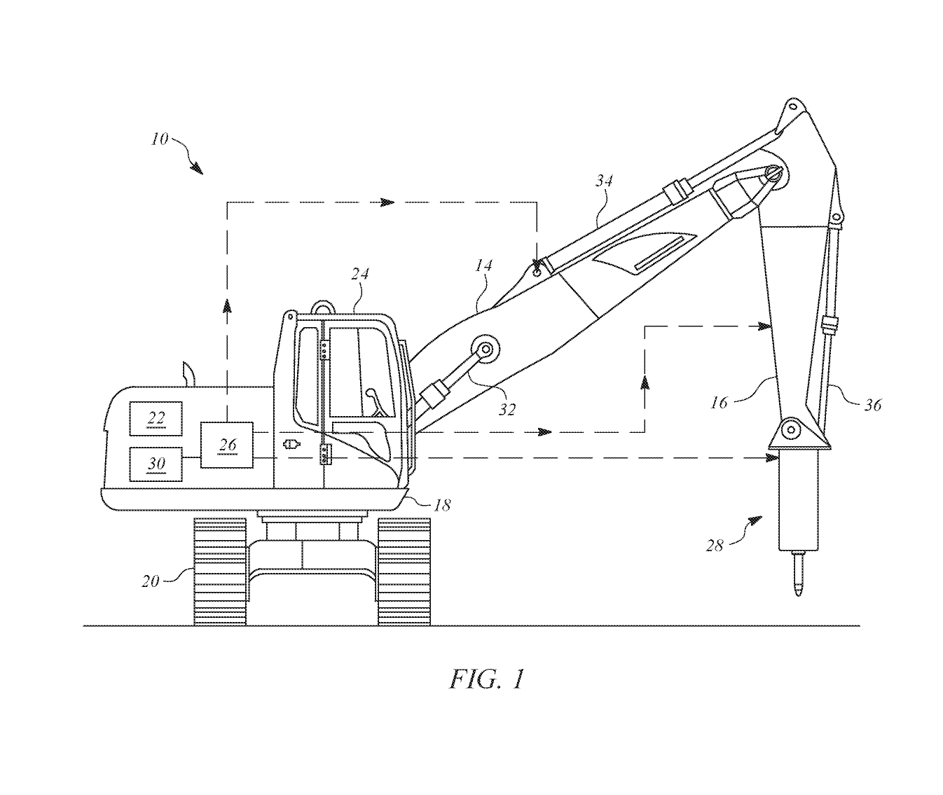

Referring to FIG. 1. a side view of an exemplary machine 10 is illustrated. The machine 10 may include, but is not limited to, an excavator, a backhoe loader, a skid steer loader, a wheel loader, and a long reach excavator. In the illustrated embodiment, the machine 10 is shown as an excavator-type earthmoving machine. The machine 10 includes linkages, such as a boom 14 and a stick 16. The boom 14 is pivotally connected to a chassis 18 of the machine 10 and the stick 16 is pivotally connected to the boom 14. The machine 10 includes a drive system 20, such as tracks, for propelling the machine 10 and a power source 22, such as an engine, to operate the drive system 20. The machines 10 includes an operator cab 24 having user interface devices for controlling the boom 14, the stick 16, and the drive system 20. Owing to the presence of the control devices within the operator cab 24, an operator can control various operations of the machine 10. The power source 22 may produce mechanical power output that may be converted to hydraulic power by a hydraulic system 26 for operating a hydraulic hammer 28 during operation of the machine 10 and for moving the boom 14 and the stick 16. The chassis 18 is rotatable about a vertical-axis (not shown) with respect to the drive system 20.

The hydraulic hammer 28 is pivotally connected to the stick 16 and is in fluid communication with the hydraulic system 26 of the machine 10. The hydraulic system 26 includes a tank 30 for storing hydraulic fluid. A pump (not shown) is disposed in fluid communication with the tank 30. The pump draws hydraulic fluid from the tank 30, pressurizes the hydraulic fluid and supplies the pressurized hydraulic fluid, to the hydraulic hammer 28, the boom 14, and the stick 16. The hydraulic fluid supplied from the hydraulic system 26 is used to operate the hydraulic hammer 28, the boom 14, and the stick 16.

The boom 14 is moved, i.e., raised or lowered by a first hydraulic actuator 32 and the stick 16 is moved towards and outward with respect to the boom 14 by a second hydraulic actuator 34. A third hydraulic actuator 36 is used to move the hydraulic hammer 28 relative to the stick 16. The pump supplies hydraulic fluid to the first hydraulic actuator 32, the second hydraulic actuator 34, and the third hydraulic actuator 36.

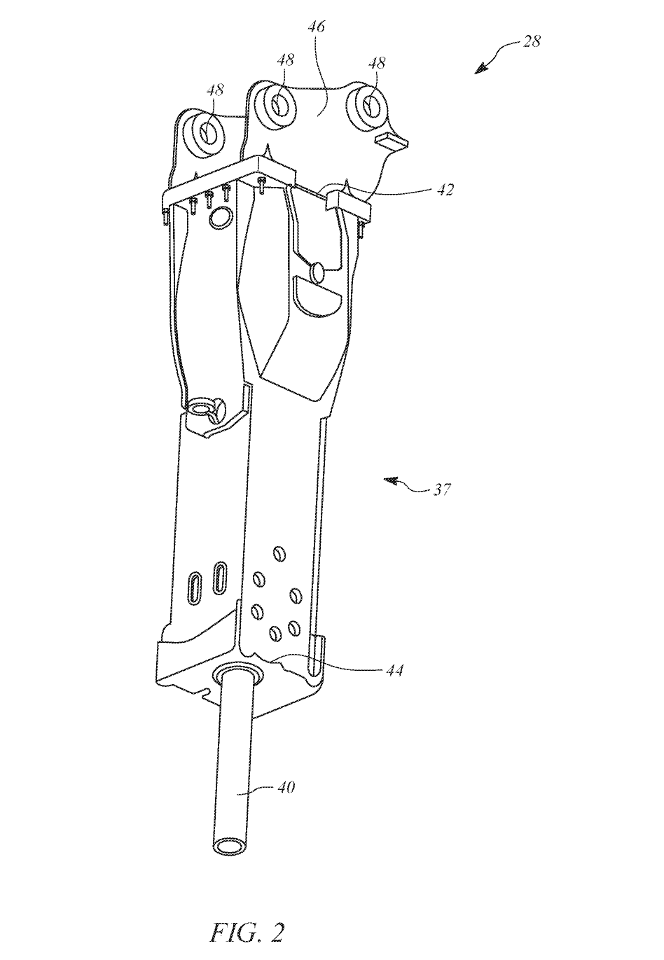

Referring to FIG. 2, the hydraulic hammer 28 includes a support structure 37 and a tool 40 received within the support structure 37. The tool 40 is adapted to break rocks and penetrate through a work surface. The hydraulic hammer 28 further includes a housing 38 accommodated within the support structure 37. The housing 38 includes a first end 42 and a second end 44. The first end 42 may be adapted to couple to a mounting member 46 of the hydraulic hammer 28. The mounting member 46 includes a plurality of pin receiving bores 48 to couple the hydraulic hammer 28 with the stick 16.

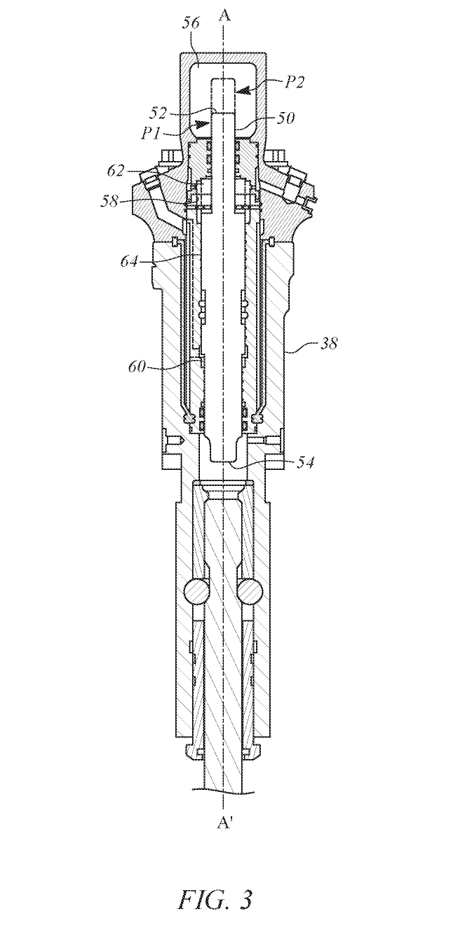

Referring to FIG. 3, the hydraulic hammer 28 includes a piston 50 movably positioned within the housing 38. The piston 50 includes a first end 52 and a second end 54. The first end 52 of the piston 50 is received in a first chamber 56 and the second end 54 of the piston 50) is located proximal to the tool 40. The housing 38 defines the first chamber 56 adapted to receive and store air and/or gas at predefined pressure. The housing 38 also defines a bore 58 which in turn defines a second chamber 60 and a third chamber 62 with an outer surface 64 of the piston 50. The second chamber 60 may be located proximal to the tool 40 and the third chamber 62 is located distal to the tool 40, within the bore 58 of the housing 38. The second chamber 60 and the third chamber 62 are characterized with varying volumes based on the movement of the piston 50 along an axis A-A′.

The bore 58 of the housing 38 defines multiple holes not shown) which are in fluid communication with the tank 30 to receive the hydraulic fluid. As such, the hydraulic fluid is supplied into the bore 58 of the hydraulic hammer 28. In particular, the hydraulic fluid is supplied into the second chamber 60, thereby causing an upward movement of the piston 50. The upward movement of the piston 50 causes the first end 52 of the piston 50 to be received within the first chamber 56, thereby decreasing the volume of the first chamber 56 and increasing the pressure of the air and/or gas present within the first chamber 56. Such increase in pressure of the air and/or gas applies pressure on the first end 52 of the piston 50. In addition, the downward movement of the piston 50 may be caused by a hydraulic switch (not shown) within the hydraulic hammer 28. Besides, the hydraulic fluid present in the third chamber 62 adds to the pressure exerted by the air anchor gas, thereby causing downward movement of the piston 50. The downward movement of the piston 50 corresponds to a movement of the piston 50 towards a first position ‘P1’ along the axis A-A′ and the upward movement of the piston 50 corresponds to a movement of the piston 50 towards a second position ‘P2’ along the axis A-A′.

Referring to FIG, 4, a schematic block diagram of a control system 66 of the hydraulic hammer 28 is illustrated. The control system 66 is used for controlling and monitoring the operation of the hydraulic hammer 28. The control system 66 includes a sensing unit 68 to sense position and rebound acceleration of the piston 50 within the housing 38. In an example, the sensing unit 68 may be located proximal to the first end 42 of the housing 38. Specifically, the sensing unit 68 senses position of the piston 50 between the first end 42 and the second end 44 of the housing 38, as the piston 50 moves there between. Although the sensing unit 68 is used for sensing position and the rebound acceleration of the piston 50, the sensing unit 68 can also be employed for sensing position and forces applied on the tool 40 during operation of the hydraulic hammer 28. In addition, the rebound acceleration of the piston 50 is directly proportional to the reaction forces applied on the tool 40 by the work surface. The sensing unit 68 includes an acceleration measurement sensor and a position detection sensor, In some implementations, the acceleration measurement sensor is an accelerometer and the position detection sensor is an ultrasonic sensor. The acceleration measurement sensor senses rebound acceleration of the piston 50. Also, the ultrasonic sensor senses the position of the piston 50. Further, the accelerometer may be positioned proximal to the second end 44 of the housing 38. Furthermore, the acceleration measurement sensor may also be placed in an inner cavity of the piston 50. In an example, the accelerometer may be positioned proximal to the first end 42 of the housing 38 and configured to also measure acceleration of the piston 50 within the housing 38 of the hydraulic hammer 28. More particularly, the accelerometer determines the piston rebound acceleration during operation of the hydraulic hammer 28.

The control system 66 further includes an electronic control module 70 (ECM) in communication with the sensing unit 68. The ECM 70 receives position of the piston 50 sensed by the sensing unit 68. Further, the ECM 70 also receives, from the sensing unit 68, signals indicative of magnitude of rebound acceleration of the piston 50 and the position of the piston 50 during downward movement of the piston 50. In some implementations, the ECM 70 may be a processor that includes one or more processing units, all of which include multiple computing units. The processor may be implemented as hardware, software, or a combination of hardware and software capable of executing a software application in some implementations, the ECM 70 may be implemented as one or more microprocessors, microcomputers, digital signal processors, central processing units, state machines, logic circuitries, and/or any device that is capable of manipulating signals based on operational instructions. Among the capabilities mentioned herein, the ECM 70 may also be configured to receive, transmit, and execute computer-readable instructions. The ECM 70 may be configured to control various systems and sub-assemblies of machines and, thus, may control many aspects of the operations of the machines. The ECM 70 stores a threshold limit of forces allowable on the piston 50 and on the tool 40 in a memory unit (not shown) of the ECM 70. The threshold limit may be dynamic and based on the rebound acceleration of the piston 50. In an example, the memory unit may be located remotely within the operator cab 24.

The ECM 70 compares the magnitude of the rebound acceleration of the piston 50 with a dynamic threshold limit of forces. More specifically, the ECM 70, in the automatic mode, compares the magnitude of the rebound acceleration of the piston 50 with the threshold limit of forces during each stroke when the tool 40 contacts the work surface. More specifically, the threshold limit is associated with forces applied and the speed at which the piston 50 reciprocates. The threshold limit indicates a value of force below which the operation of the piston 50 of the hydraulic hammer 28 operates on the work surface and achieves the blows per minute (BPM) preset by the operator during manual mode. In an example, the threshold limit may be determined based on historical data pertaining to various operations performed by the hydraulic hammer 28. In an example, the threshold limit indicates at least one of a value of threshold force, or a threshold speed of the movement of the piston 50 and the tool 40 required to achieve optimum impact energy on the material. In another example, the threshold limit indicates threshold forces acting on the tool 40 such that the tool 40 can withstand the force without breaking during the operation of the hydraulic hammer 28.

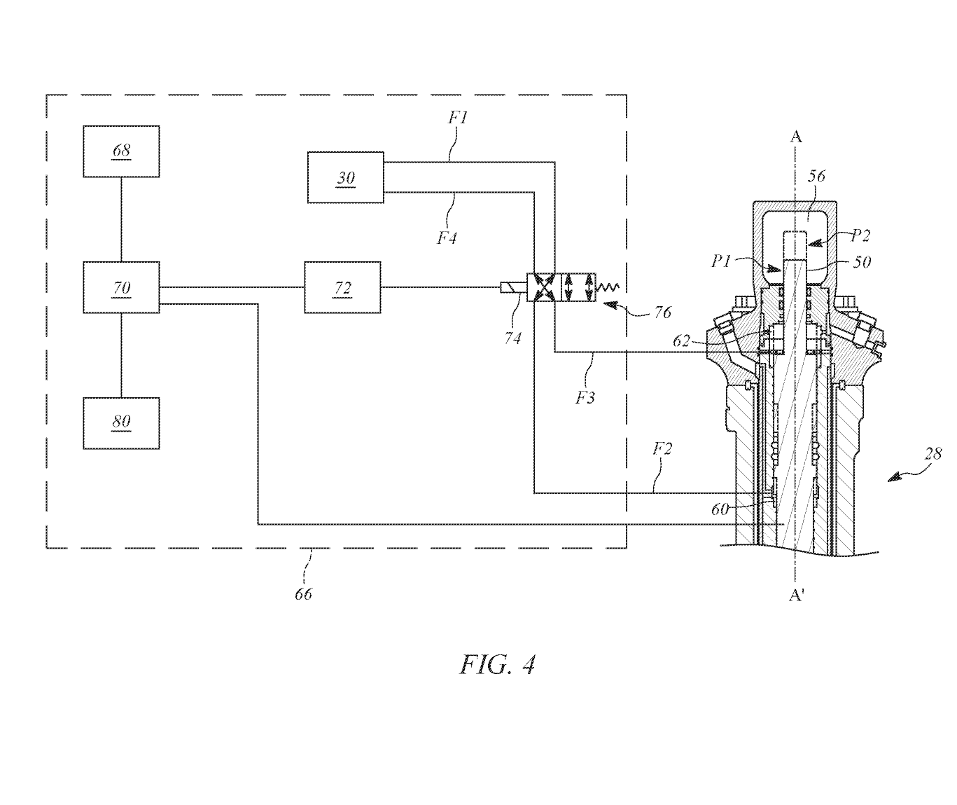

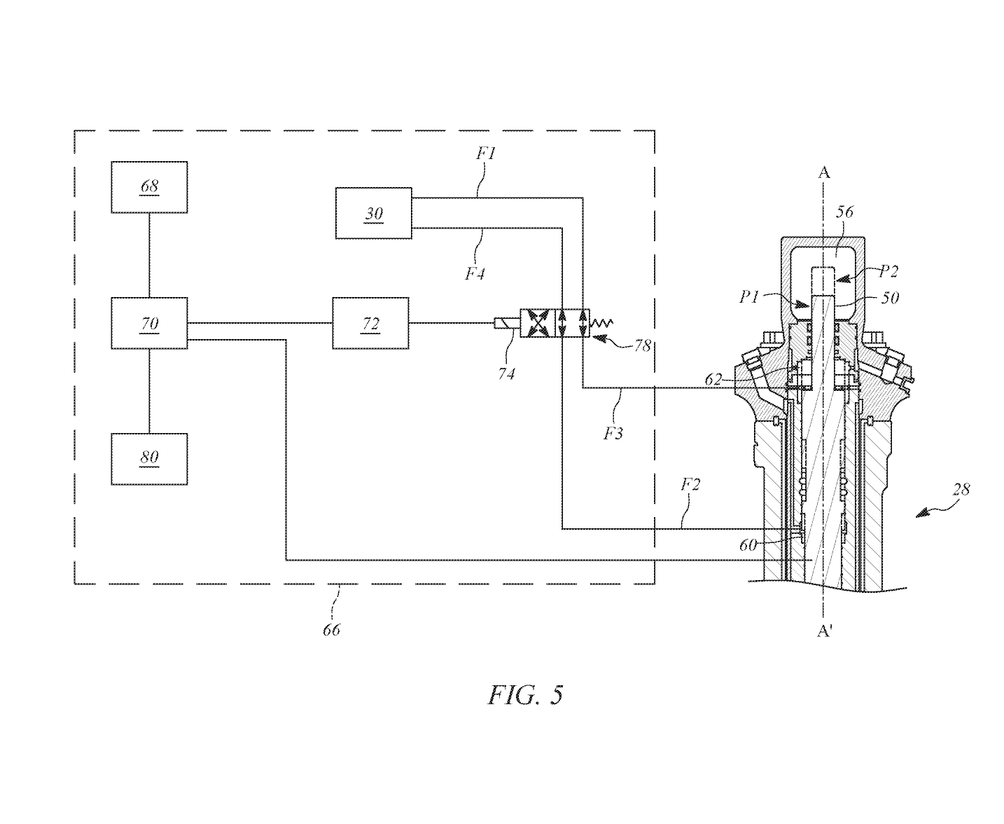

The ECM 70 communicates signals based on the comparison of the rebound acceleration of the piston 50 and the tool 40 to a relay 72 which in turn operates a valve 74. In an example the relay 72 may be embedded into the valve 74 for operating the valve 74. The relay 72 operates the valve 74 between an open position 76 (show in FIG. 4) and a closed position 78 (shown in FIG. 5) based on the signals received from the ECM 70. The relay 72 is in communication with the valve 74 and the ECM 70. The valve 74 is moved to the open position 76 which allows flow of hydraulic fluid into the second chamber 60 of the hydraulic hammer 28. The valve 74 operates between the open position 76 and the closed position 78 based on the signals generated by the ECM 70 to selectively move the piston 50.

In an example, the control system 66 further includes a selection unit 80 to receive an input from an operator. In an example, the selection unit 80 may include Blows Per Minute (BPM) adjuster in communication with the ECM 70. The selection unit 80, by taking input from the operator, allows the operator to select a mode of operation between a manual mode and an automatic mode. In the manual mode, the operator manually selects number of blows per minute desired based on worksite specific requirement or based on the work surface. More specifically, the operator presets the number of blows to be performed by the piston 50 of the hydraulic hammer 28. In an example, blows per minute (BPM) adjuster may be used by the operator to preset the number of blows per minute during operation of the hydraulic hammer 28 depending on the type of work surface. Owing to the connection between the ECM 70 and the BPM adjuster, the ECM 70 supplies a current to the valve 74 based on the selection by the operator. On receipt of the current from the ECM 70, the valve 74 operates the hydraulic hammer 28.

In the automatic mode, the sensing unit 68 senses values of rebound acceleration of the piston 50 and the piston 50 position within the hydraulic hammer 28. Upon sensing the reaction rebound acceleration of the piston 50 exceeding or nearing the threshold limit, the ECM 70 adjusts the piston 50 movement to reduce or increase the piston stroke. This in turn will proportionately increase or decrease the impact force on the tool and hence the work surface. In particular, the sensing unit 68 senses the rebound acceleration of the piston 50 and communicates the sensed rebound acceleration of the piston 50 to the ECM 70. Thus the control system 66 always operates the hydraulic hammer 28 in a way proportional to the hardness of the work surface which makes it optimal for operating on the work surface.

During operation of the hydraulic hammer 28, the hydraulic system 26 of the machine 10 supplies the hydraulic fluid into the second chamber 60 of the hydraulic hammer 28 via a first fluid. supply line ‘F1’, the valve 74, and a second fluid supply line ‘F2’. As the hydraulic fluid is continuously supplied into the hydraulic hammer 28 through the second fluid supply line ‘F2’, pressure is developed within the second chamber 60 inside the hydraulic hammer 28, which then actuates the piston 50 to move from the first position ‘P1’ to the second position ‘P2’. As the process of supplying hydraulic fluid into the hydraulic hammer 28 is continuous, the sensing unit 68 of the control system 66 continuously senses the position of the piston. The sensing unit 68 communicates the sensed position of the piston 50 to the ECM 70. The ECM 70 compares the determined position of the piston 50 with the threshold position of the piston 50. The ‘threshold position’ of the piston 50 may he understood as a position beyond which if the piston reaches, downstroke begins. The ECM 70 then communicates signals to the relay 72, based on the comparison, which in turn actuates the valve 74. For instance, when the position of the piston 50 is below the threshold position, the ECM 70, via the relay 72, switches the valve 74 to the open position 76 which allows flow of hydraulic fluid into the second chamber 60 of the hydraulic hammer 28. As the second chamber 60 is filled with the hydraulic fluid, the second chamber 60 causes movement of the piston 50 to the first position ‘P1’ in the upward direction along the axis A-A′. More specifically, the ECM 70 actuates the valve 74 to be in the open position 76 (as shown in FIG. 4), thus moving the piston 50 to the first position ‘P1’ in the upward direction. The hydraulic fluid present in the third chamber 62 is forced towards the tank 30 through a third fluid supply line ‘F3’, the valve 74, and a fourth fluid supply line ‘F4’.

Referring to FIG. 5, a schematic block diagram of the control system 66 of the hydraulic hammer 28 is illustrated. During downward movement of the piston 50, the hydraulic system 26 of the machine 10 supplies the hydraulic fluid into the third chamber 62 of the hydraulic hammer 28 via the first fluid supply line the valve 74, and the third fluid supply line ‘F3’. As the hydraulic fluid. is continuously supplied into the third chamber 62 of the hydraulic hammer 28 through the third fluid supply line ‘F3’, pressure is developed within the third chamber 62 inside the hydraulic hammer 28, which then actuates the piston 50 to move from the second position ‘P2’ to the first position ‘P1’. As the process of supplying hydraulic fluid into the hydraulic hammer 28 is continuous, the sensing unit 68 of the control system 66 continuously senses the position of the piston 50. The sensing unit 68 communicates the position sensed of the piston 50 to the ECM 70. The ECM 70 compares the determined position of the piston 50 with the threshold position of the piston 50. The ECM 70 then communicates signals to the relay 72, based on the comparison, which in turn actuates the valve 74. For instance, when the position of the piston 50 is above the threshold position, the ECM 70, via the relay 72, switches the valve 74 to the closed position 78 which restricts flow of hydraulic fluid into the second chamber 60 and directs the hydraulic fluid to the third chamber 62 of the hydraulic hammer 28. The hydraulic fluid occupying the third chamber 62 develops a pressure within the third chamber 62, where the developed pressure causes thrust to be applied on a neck portion of the piston 50. In addition, the pressure built up in the first chamber 56, due to decrease in volume of the first chamber 56, applies a downward thrust on the first end 52 of the piston 50. Once the piston 50 reaches the upper threshold, the ECM 70 receives the signal and then switches the valve 74 from the open position 76 to the closed position 78. Owing to such switching of the valve 74, the direction of flow of the hydraulic fluid changes, thereby starting the downward movement of the piston 50. Further downward movement of the piston 50, which is associated with sufficient thrust, contacts the tool 40 to break the work surface. Based on the impact caused by the tool 40 on the work surface, the tool 40 rebounds into the housing 38, thereby causing rebound of the piston 50 in the upward direction along the axis A-A′. Such rebound of the piston 50 is associated with an acceleration, which, for the purpose this description is referred to as the ‘rebound acceleration’. Further, the ECM 70 senses the rebound acceleration of the piston 50 to determine type of work surface. Based on the determination, the ECM 70 controls operation of the hydraulic hammer 28. For example, when the work surface is hard, such as rock, impact energy is increased and the number of blows per minute (BPM) is decreased. On the contrary, when the work surface is less hard as compared to rock, the impact energy is decreased and the number of blows per minute (BPM) is increased.

### INDUSTRIAL APPLICABILITY

The present disclosure relates to the control system 66 for the hydraulic hammer 28. The control system 66 is used for controlling and monitoring operation of the hydraulic hammer 28. As mentioned earlier, the selection unit 80 includes the manual mode and the automatic mode. In the manual mode, the operator can vary blows per minute or the impact energy for a given fluid flow rate. As such, the hydraulic hammer 28 can be used at the worksite according to specific customer and site requirements. As the hydraulic hammer 28 is controlled using the ECM 70 of the control system 66, site specific adaptability and monitoring of the components of the hydraulic hammer 28 is possible. More specifically, if the hydraulic hammer 28 is operating on a work surface that is hard in nature, the sensing unit 68 senses the type of surface and communicates to the ECM 70. The ECM 70 increases the impact energy and decreases the blows per minute at which the piston 50 operates to ensure smooth operation of the hydraulic hammer 28. The ECM 70 can adjust the number of blows per minute based on the comparison between the rebound acceleration of the piston 50 with the threshold limit. Likewise, if the hydraulic hammer 28 is operating on a work surface that is loose in nature, the sensing unit 68 senses the type of surface based on rebound acceleration of the tool 40 and communicates to the ECM 70. The ECM 70 decreases the forces applied and increases the speed at which the piston 50 operates for optimum performance of the hydraulic hammer 28. As the ECM 70 can control the operation of the piston 50, safe operation of the hydraulic hammer 298 is ensured. As a result, the sensing unit 68 and the ECM 70 notifies the type of work surface and the optimum operating parameters to the operator. In situations where the hydraulic hammer 28 is operating in contrary to optimum operating parameters, the ECM 70 can communicates a notification indicative of non optimal operating conditions of the hydraulic hammer 28. Owing to the electronic monitoring of the hydraulic hammer 28, the control system 66 aids in monitoring and improving the hydraulic hammer 28 performance and assists in predicting premature failure of the hydraulic hammer 28. Also, the number of parts used as compared to the conventional hydraulic hammer can be reduced with the present hydraulic hammer 28, thus reducing the overall machine payload.

What is claimed is:

1. A control system for a hydraulic hammer, the control system comprising:
a sensing unit configured to sense position and rebound acceleration of a piston of the hydraulic hammer;
an electronic control module (ECM) in communication with the sensing unit, and configured to generate signals based on the sensed position and rebound acceleration of the piston;
a selection unit in communication with the electronic control module (ECM) and configured to allow an operator to select between a manual mode and an automatic mode, wherein in the manual mode the operator selects number of blows per minute for the hydraulic hammer, and in the automatic mode, upon sensing threshold limit of rebound acceleration of the piston, the electronic control module (ECM) adjusts piston movement based on a work surface; and
a valve in communication with the electronic control module (ECM), the valve being configured to be operated between a closed position and an open position based on the signals generated by the electronic control module (ECM) to selectively move the piston.

2. A hydraulic hammer comprising:
a housing;
a piston movably positioned within the housing;
a tool configured to receive power from the piston; and
a control system including:
a sensing unit configured to sense position and rebound acceleration of the piston of the hydraulic hammer;
an electronic control module (ECM) in communication with the sensing unit, and configured to generate signals based on the sensed position and rebound acceleration of the piston;
a selection unit in communication with the electronic control module (ECM) and configured to allow an operator to select between a manual mode and an automatic mode, wherein in the manual mode the operator selects number of blows per minute for the hydraulic hammer, and in the automatic mode upon sensing threshold limit of rebound acceleration of the piston, the electronic control module (ECM) adjusts piston movement based on a work surface and
a valve in communication with the electronic control module (ECM), the valve being configured to be operated between a closed position and an open position based on the signals generated by the electronic control module (ECM) to selectively move the piston.
